(19) United States
(12) Patent Application Publication
(10) Pub. No.: US 2011/0145703 A1
(43) Pub. Date: Jun. 16, 2011

(54) Interactive Programming Mechanism

(76) Inventor: Maryamossadat Nematollahi Mahani, Lawrence, KS (US)

(21) Appl. No.: 12/635,089

(22) Filed: Dec. 10, 2009

(51) Int. Cl. G06F 3/14; G06F 3/048

(52) U.S. Cl. 715/274; 715/810

(57) ABSTRACT

A method disclosed. The method includes receiving a menu option selection from a function generator window within a graphical user interface (GUI), generating programming code having a function corresponding to the menu option selection and displaying the programming code at a preview window within the GUI.

### FIELD OF THE INVENTION

The invention relates to the field of software development, and in particular, to developing programming code for printing systems.

### BACKGROUND

Print systems include presentation architectures that are provided for representing documents in a data format that is independent of the methods that are utilized to capture or create those documents. One example of presentation system, is the (Advanced Function Presentation) AFP™ system developed by International Business Machines Corporation. According to the AFP system, documents may include combinations of text, image, graphics, and/or barcode objects in device and resolution independent formats. Documents may also include and/or reference fonts, overlays, and other resource objects, which are required at presentation time to present the data properly.

Additionally, documents may also include resource objects, such as a document index and tagging elements supporting the search and navigation of document data for a variety of application purposes. In general, a presentation architecture for presenting documents in printed format employs a presentation data stream. To increase flexibility, this stream can be further divided into a device-independent application data stream and a device-dependent printer data stream. A data stream is a continuous ordered stream of data elements and objects that conform to a given formal definition. Application programs can generate data streams destined for a presentation device, archive library, or another application program.

Typically the data streams are generated by user via programming language code. Thus, it is often necessary for a printer operator (or user) to have programming experience. However for operators without programming experience, it is difficult to code a function that may be considered preliminary by a programmer. Further, any attempt to learn coding in a specific language often requires the user to read certain tutorials and books to learn the semantic and syntax for the language.

Accordingly, a mechanism to assist in the generation of programming code while teaching an operator the code language is desired.

### SUMMARY

In one embodiment a computer system is disclosed including a memory to store a printer driver program, a processor, coupled to the memory, to execute the printing product and a display device to display a GUI upon the processor executing the printing product. The GUI includes a function generator window to automatically generate a programming code file upon selection of one or more menu options within the function generator window and a preview window to display programming code functions associated with each of the selected menu options

In another embodiment, a computer generated method disclosed. The method includes receiving a menu option selection from a function generator window within a GUI, generating programming code having a function corresponding to the menu option selection and displaying programming code at a preview window within the GUI.

In a further embodiment a GUI includes a function generator window to automatically generate a programming code file upon selection of one or more menu options within the function generator window and a preview window to display programming code functions associated with each of the selected menu options.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIGS. 2A-2F are screen shots of various embodiments of a GUI; and

FIG. 3 illustrates one embodiment of a computer system.

### DETAILED DESCRIPTION

A file path mapping mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

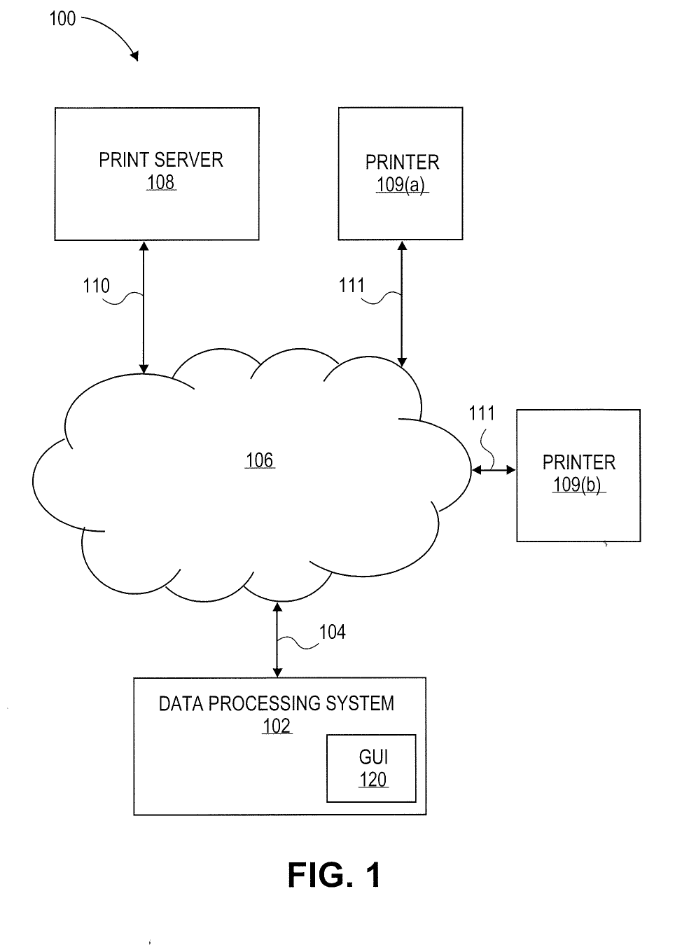

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system, or other operating system, and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

In one embodiment, a print application at data processing system 102 allows a user to select the desired print server 108 and submit requests for service requests to printer 109 via print server 108 over network 106. In a further embodiment, the print application provides a Mixed Object Document Content Architecture (MO:DCA) data stream to print server 108.

According to one embodiment, the AFP MO:DCA data streams are object-oriented streams including, among other things, data objects, page objects, and resource objects. In a further embodiment, AFP MO:DCA data streams include a Resource Environment Group (REG) that is specified at the beginning of the AFP document, before the first page. When the AFP MO:DCA data streams are processed by print server 108, the REG structure is encountered first and causes server 108 to download any of the identified resources that are not already present in the printer.

Although described as separate entities, other embodiments may include print server 108 being incorporated in one or more of the printers 109. However in other embodiments, the print server and printer may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 and one or more of printers 109. In other embodiments, the printing software product manages printing of documents from multiple data processing systems 102 to the one or more printers 109.

According to one embodiment, the printing software product may be implemented using either InfoPrint Manager (IPM) or InfoPrint ProcessDirector (IPPD), although other types of printing software may be used instead. In a further embodiment, the print application at data processing system 102 interacts with the printing software product to provide for efficient transmission of print jobs.

In one embodiment, the printing software product includes a graphical user interface (GUI) 120 accessible at a data processing system 102 that enables a system administrator (or operator) to interact with the printing software product and print application. In such an embodiment, GUI 120 includes an AFP programming window that enables an operator to generate a AFP control file.

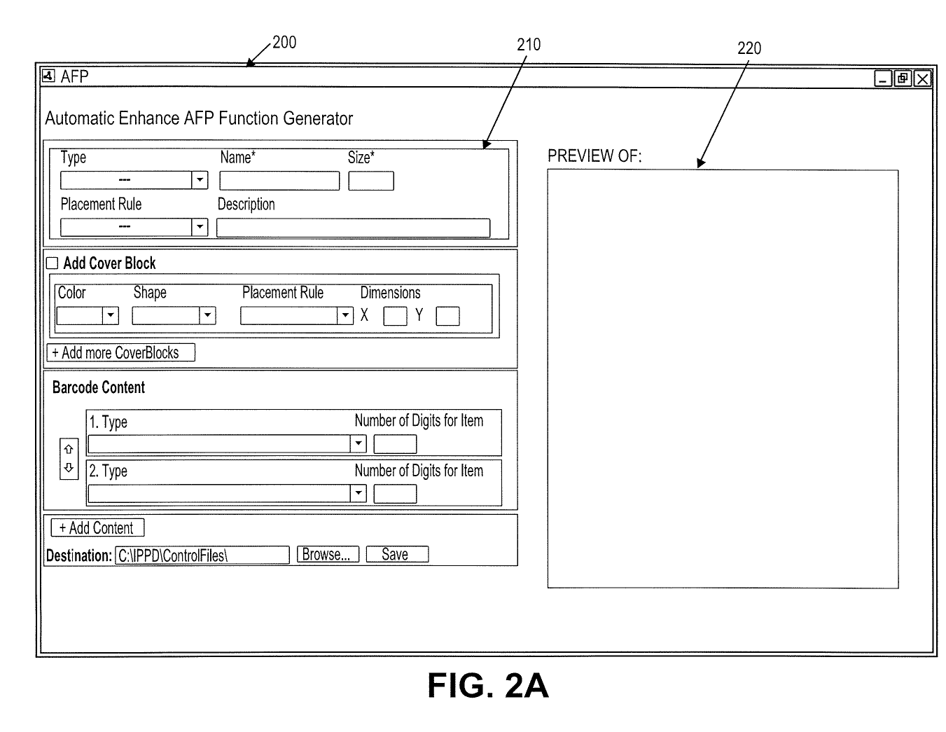

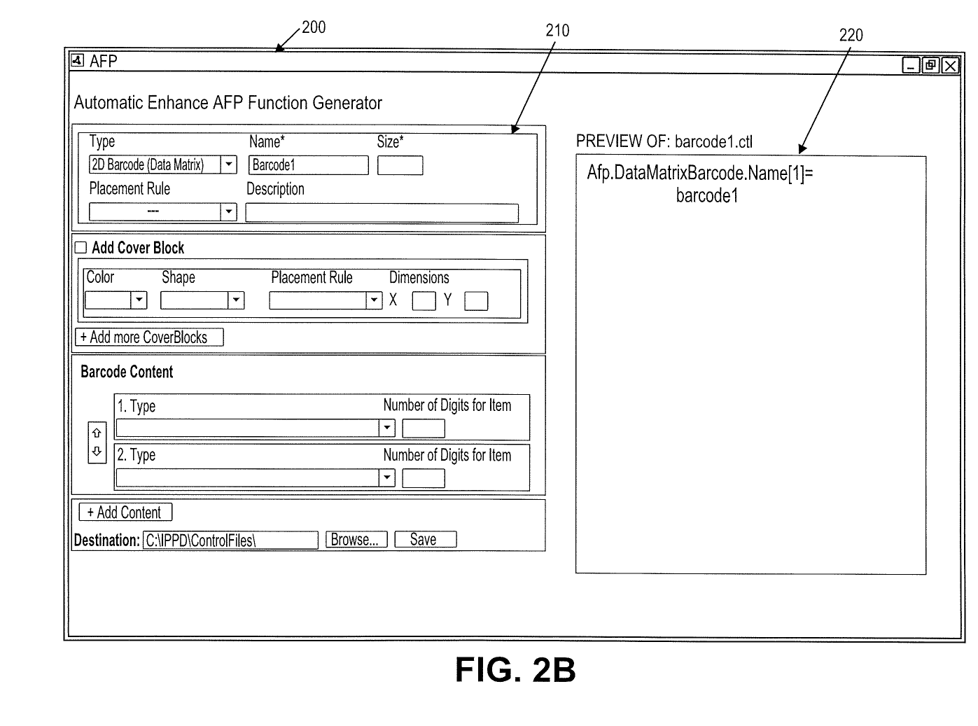

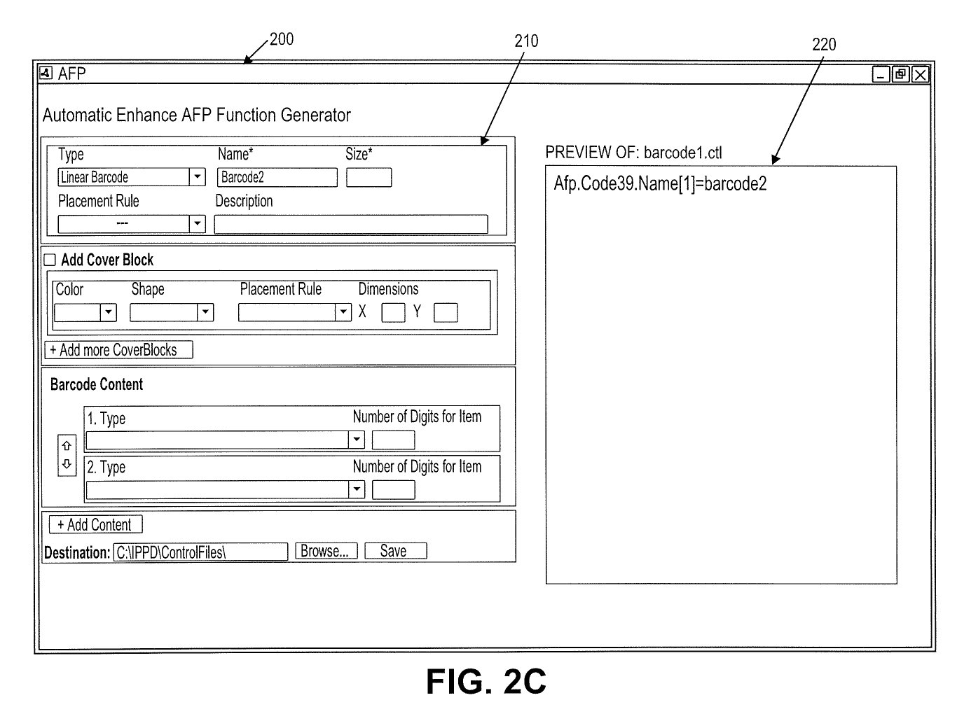

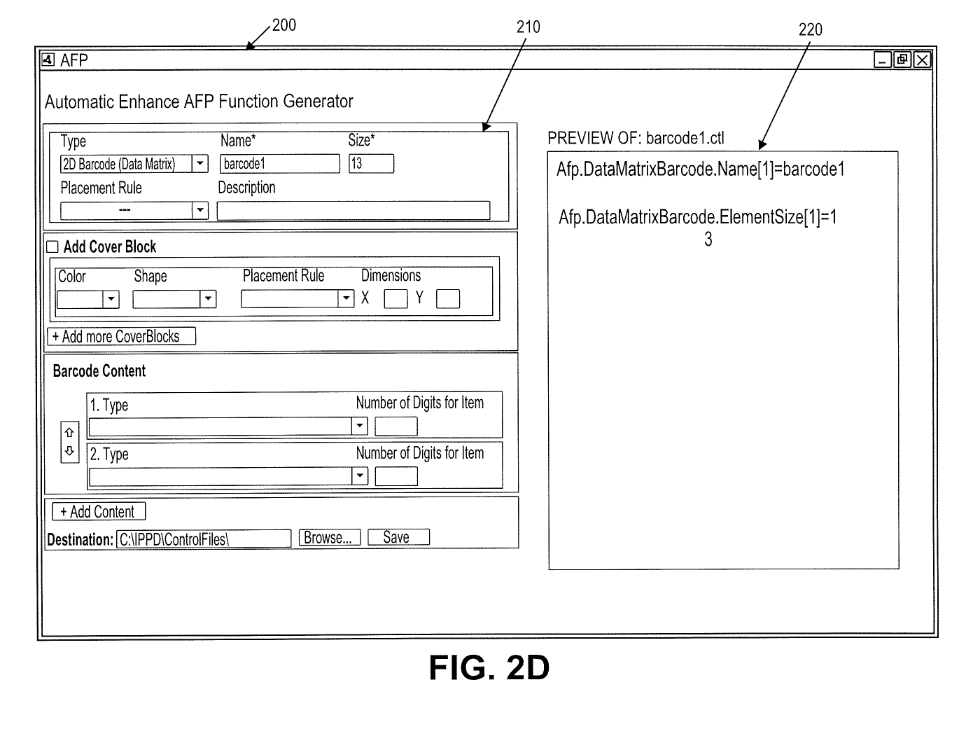

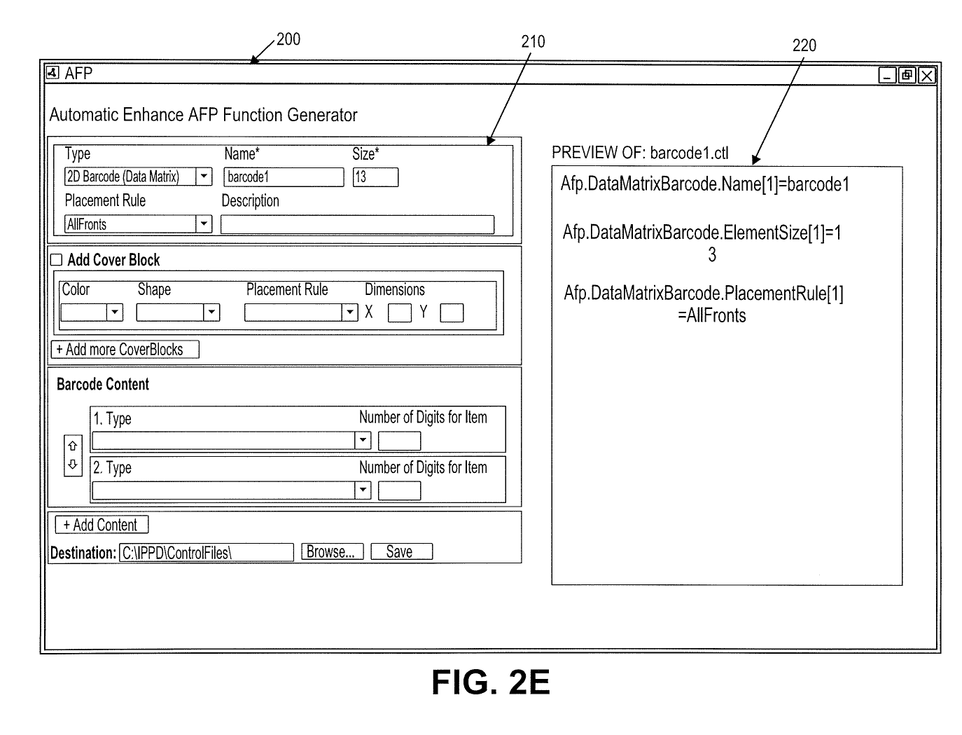

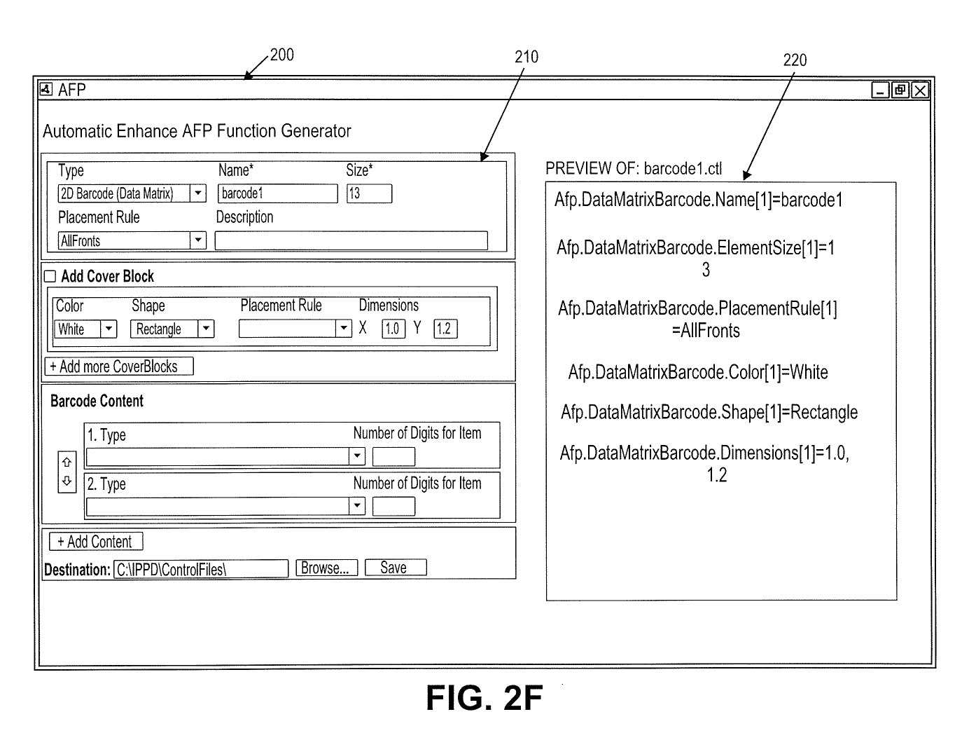

FIG. 2A illustrates a screen shot of one embodiment of GUI 120 AFP programming window 200. As shown in FIG. 2A, the AFP programming window includes an automatic AFP function generator window 210 and a preview window 220. AFP function generator window 210 enables an operator to select from among a menu of function options for which programming code for a AFP control file is automatically generated. The AFP programming code resulting from a selection is shown in preview window 220. Therefore, preview window 220 provides a demonstration to the operator of the generation of the programming code language and reflects changes in code that are caused by the operator's actions in AFP function generator window 210.

In one embodiment, AFP function generator window 210 provides option buttons and text boxes, the selection of which enables the generation of AFP barcode functions. For instance, window 210 includes buttons that enable an operator to select a type, placement and color of a barcode, while text boxes enable the selection of a name and size of the barcode.

FIG. 2B illustrates a screen shot of another embodiment of GUI 120 AFP programming window, where a 2D barcode has been selected and named “barcode1”. As a result, corresponding code (Afp.DataMatrixBarcode.Name[1]=barcode1) is shown in preview window 220. In this embodiment, the function “Afp.DataMatrixBarcode” corresponds to the 2D barcode (Data Matrix) type selected, while “Name[1]=barcode1” corresponds to the name entered.

FIG. 2C illustrates a screen shot of yet another embodiment of GUI 120 AFP programming window, where a linear barcode has been selected and named “barcode2”. Similarly, corresponding code (Afp.Code39.Name[1]=barcode2) is shown in preview window 220.

FIG. 2D illustrates a screen shot of still another embodiment of GUI 120 AFP programming window, after a size (e.g., 13) has been selected for “barcode 1”. As shown in preview window 220, the function “Afp.DataMatrixBarcode.ElementSize[1]=13” is displayed, where “ElementSize[1]=13” corresponds to the selected size.

FIG. 2E illustrates a screen shot of a further embodiment of GUI 120 AFP programming window, after a placement rule (e.g., AllFronts) has been selected for “barcode 1. In this instance, the function Afp.DataMatrixBarcode.PlacementRule[1]=AllFronts” is displayed in preview window 220, where “PlacementRule[1]=AllFronts” corresponds to the placement rule.

FIG. 2F illustrates a screen shot of yet a further embodiment of GUI 120 AFP programming window, after a color, shape and dimensions are selected for “barcode 1”. As a result, three additional lines of programming code are displayed in preview window 220. “Afp.DataMatrixBarcode.Color[1]=White” is the code corresponding to the color selection, while

### “Afp.DataMatrixBarcode.Shape[1]=Rectangle” and

“Afp.DataMatrixBarcode.Dimensions[1]=1.0,1.2” correspond to the shape and dimensions selections, respectively.

According to one embodiment, manually entering and/or editing AFP programming code in preview window 220 results in the an automatic button selection in AFP function generator window 210. For example, an operator editing the barcode size by changing the corresponding code to

“Afp.DataMatrixBarcode.ElementSize[1]=12” in preview window 220, results in the size tool at AFP function generator window 210 being automatically changed to “12”.

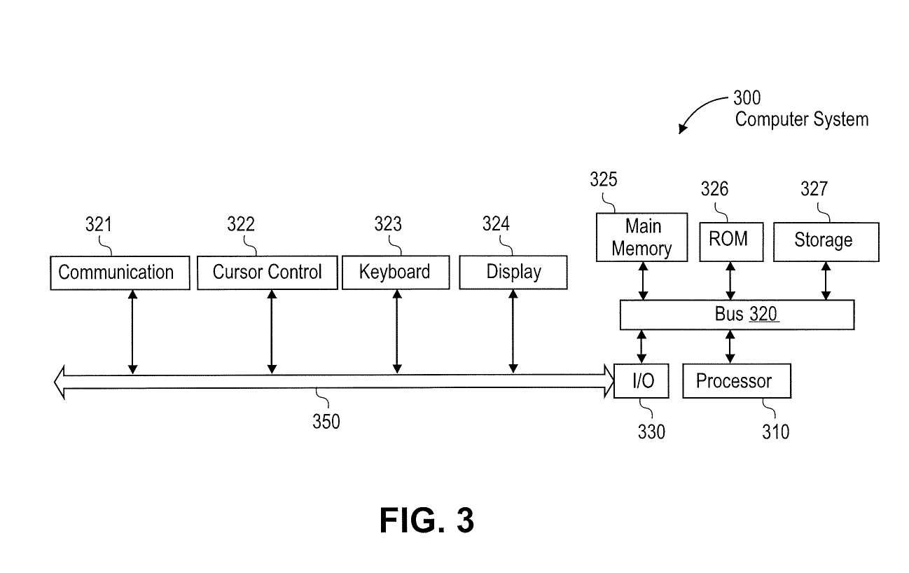

FIG. 3 illustrates a computer system 300 on which data processing system 102 and/or server 108 may be implemented. Computer system 300 includes a system bus 320 for communicating information, and a processor 310 coupled to bus 320 for processing information.

Computer system 300 further comprises a random access memory (RAM) or other dynamic storage device 325 (referred to herein as main memory), coupled to bus 320 for storing information and instructions to be executed by processor 310. Main memory 325 also may be used for storing temporary variables or other intermediate information during execution of instructions by processor 310. Computer system 300 also may include a read only memory (ROM) and or other static storage device 326 coupled to bus 320 for storing static information and instructions used by processor 310.

A data storage device 325 such as a magnetic disk or optical disc and its corresponding drive may also be coupled to computer system 300 for storing information and instructions. Computer system 300 can also be coupled to a second I/O bus 350 via an I/O interface 330. A plurality of I/O devices may be coupled to I/O bus 350, including a display device 324, an input device (e.g., an alphanumeric input device 323 and or a cursor control device 322). The communication device 321 is for accessing other computers (servers or clients). The communication device 321 may comprise a modem, a network interface card, or other well-known interface device, such as those used for coupling to Ethernet, token ring, or other types of networks.

The above-described GUI enables users with little or no programming experience to create a control file, while at the same time learning a programming language by observing the generation of code as function options are selected or filled out. Although described with reference to barcodes, one of ordinary skill in the art would appreciate that the GUI may be used to generate code for other types of AFP objects. Further, the GUI may be implemented to create files for other programming languages.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer system comprising:
a memory to store a printer driver program;
a processor, coupled to the memory, to execute the printing product; and
a display device to display a graphical user interface (GUI) upon the processor executing the printing product, the GUI having a function generator window to automatically generate a programming code file upon selection of one or more menu options within the function generator window, and a preview window to display programming code functions associated with each of the selected menu options.

2. The computer system of claim 1 wherein the menu options comprise:
one or more buttons each having two or more options; and
one or more text boxes.

3. The computer system of claim 2 wherein selection of a first option at a first button results in the display of a first line of programming code in the preview window having a first function associated with the first button option.

4. The computer system of claim 3 wherein selection of a second option at the first button results in the display of the first line of programming code in the preview window having a second function associated with the second button option.

5. The computer system of claim 3 wherein selection of a first option at a second button results in the display of a second line of programming code in the preview window having a second function associated with the second button option.

6. The computer system of claim 3 wherein entering text in a first text box in the display of a second line of programming code in the preview window having a second function associated with the first text box.

7. The computer system of claim 3 wherein entering the first function in the preview window results in automatic selection of the first option associated with the first button.

8. The computer system of claim 6 wherein entering the second function in the preview window results in the text being automatically entered into the first text box.

9. The computer system of claim 1 wherein the preview window provides for demonstration of the generation of the programming code file in a particular programming code language.

10. The computer system of claim 9 wherein the programming code file is a Advanced Function Presentation (AFP) File.

11. A computer generated method comprising:
receiving a menu option selection from a function generator window within a graphical user interface (GUI);
generating a first line of programming code having a function corresponding to the menu option selection; and
displaying the first line of programming code at a preview window within the GUI.

12. The method of claim 11 wherein selecting a menu option comprises selecting a button having two or more options or entering text into a text box.

13. The method of claim 12 further comprising:
selecting a first option at a first button; and
displaying the first line of programming code in the preview window having a first function associated with the first button option.

14. The method of claim 13 further comprising:
selecting a second option at the first button; and
displaying the first line of programming code in the preview window having a second function associated with the second button option.

15. The method of claim 13 further comprising:
selecting a first option at a second button; and
displaying a second line of programming code in the preview window having a second function associated with the second button option.

16. The method of claim 13 further comprising:
entering text in a first text box; and
displaying a second line of programming code in the preview window having a second function associated with the first text box.

17. The method of claim 13 further comprising:
entering the first function in the preview window; and
selecting the first option associated with the first button in response entering the first function.

18. The method of claim 16 further comprising:
entering the first function in the preview window; and
entering text into the first text box identifying the first function.

19. A graphical user interface (GUI) comprising:
a function generator window to automatically generate a programming code file upon selection of one or more menu options within the function generator window; and
a preview window to display programming code functions associated with each of the selected menu options.

20. The GUI of claim 11 wherein the menu options the function generator window comprise:
one or more buttons each having two or more options; and
one or more text boxes.
